(19) United States
(12) Patent Application Publication
(10) Pub. No.: US 2012/0326507 A1
(43) Pub. Date: Dec. 27, 2012

(54) POWER CONVERSION APPARATUS HAVING CASING ACCOMMODATED WITH A PLURALITY OF CIRCUIT BOARDS

(75) Inventors: Shinji Usami, Okazaki-shi (JP); Masakazu Tago, Aisai-shi (JP); Atsuyuki Hiruma, Kariya-shi (JP)

(73) Assignee: DENSO CORPORATION, Kariya-city (JP)

(21) Appl. No.: 13/534,320

(22) Filed: Jun. 27, 2012

(30) Foreign Application Priority Data
Jun. 27, 2011 (JP) 2011-141332

(51) Int. Cl. H02J 1/00

(52) U.S. Cl. 307/31

(57) ABSTRACT

An apparatus for converting power of a power source used for a main unit mounted on a vehicle includes: a first circuit that converts the power into a first power and supplies the first power to a first auxiliary unit mounted on the vehicle; a second circuit that converts the power into a second power and supplies the second power to a second auxiliary unit mounted on the vehicle; a first board on which the first circuit is mounted; a second board on which the second circuit is mounted; and a connecting member that electrically connects between the first board and the second board to allow the power of the power source to be conducted therebetween.

### CROSS REFERENCE TO RELATED APPLICATION

This application is based on and claims the benefit of priority from earlier Japanese Patent Application No. 2011-141332 filed on Jun. 27, 2011 the description of which is incorporated herein by reference.

### BACKGROUND

1. Technical Field

The present disclosure relates to power conversion apparatuses, and more particularly to a power conversion apparatus having a power conversion circuit that supplies an on-vehicle auxiliary unit with power converted from power supplied to an on-vehicle main unit.

2. Description of the Related Art

This type of apparatus has been widely used for power conversion in the vehicle systems. For example, Japanese Patent Application Publication No. 2002-345252 discloses an apparatus provided with a plurality of power conversion circuits.

Assuming a plurality of power conversion circuits are required to supply power to the on-vehicle auxiliary unit, the space where the power conversion circuits are to be arranged is likely to be restricted, and therefore it is preferable to shrink the power conversion circuits. In this instance, when a plurality of power conversion circuits need to be shrunk, the power conversion circuits can be disposed effectively on a single circuit board. However, since heat radiation from each of the power conversion circuits becomes larger, excessive thermal stress may be applied to the single circuit board.

### SUMMARY

An embodiment provides a newly developed power conversion apparatus having a power conversion circuit that supplies power used for an on-vehicle main unit to an on-vehicle auxiliary unit.

As a first aspect of the embodiment, an apparatus for converting power of a power source used for a main unit mounted on a vehicle includes: a first circuit that converts the power into a first power and supplies the first power to a first auxiliary unit mounted on the vehicle; a second circuit that converts the power into a second power and supplies the second power to a second auxiliary unit mounted on the vehicle; a first board on which the first circuit is mounted; a second board on which the second circuit is mounted; and a connecting member that electrically connects between the first board and the second board to allow the power of the power source to be conducted therebetween.

According to the first aspect of the embodiment, considering space for disposing the conversion boards is limited, the conversion boards need to be shrunk. However, the first circuit and the second circuit are disposed on separated circuit boards. As a result, an amount of heat radiation from a single conversion board can be reduced so that excessive stress applied to the circuit board can be suppressed.

As a second aspect of the embodiment, the apparatus includes a casing that accommodates the first board and the second board. The casing includes a first connector that electrically connects between the first circuit and the first auxiliary unit, and a second connector that electrically connects between the second circuit and the second auxiliary unit. The first and second connectors are disposed on the same surface of the casing.

When the connectors of the first and second circuits are disposed on the same side surface of the casing, comparing to the connectors of the first and second being arranged on each side surface separately, first and second circuits may be arranged to be one-sided to one side surface of the pair of side surfaces facing each other so that location at which heat is generated is one-sided to the one side surface. Therefore, in view of accelerating heat radiation of the first and second circuits, this arrangement would be disadvantageous comparing with the circuit boards being arranged on each of the side surfaces. However, according to the embodiment of the present disclosure, separate circuit boards are arranged in the power conversion apparatus. As a result, degrading heat-radiation characteristics because of the connectors being arranged on the identical side surface, can preferably be compensated for.

As a third aspect of the embodiment, the apparatus includes a power supply board on which a power supply unit used for supplying the power of the power source to the first and second circuits is disposed; and a casing that accommodates the first board, the second board and the power supply board. The first board, the second board and the power supply board are arranged in a single row, and the power supply board is disposed in an end portion of the casing.

According to the third embodiment, the power of the power supply board can be sequentially transferred to a circuit board adjacent to the power supply board and the other circuit board which is not adjacent to the power supply board. Therefore, a wiring pattern used for supplying power on the power supply board can readily be accomplished. Moreover, the number of connecting devices mounted on the power supply board can be reduced so that the size of the power supply board which is likely to be large can be shrunk as much as possible.

As a fourth aspect of the embodiment, the first and second circuits are operated at mutually different switching frequencies.

The inventors have found that when the switching frequencies of the first and second circuit thereof are different to each other, the power supply unit is shared by the first and second circuits whereby necessary power for the first and second circuits is supplied by the shared power supply unit of which power supply capability (i.e., rated power output) is smaller than sum of the power supply capability of respective power supply units when the power supply units are arranged individually for each of the first and second circuits. Therefore, according to the embodiment, the power supply unit can be shrunk based on the above-described configuration.

As a fifth aspect of the embodiment, the apparatus includes a casing that accommodates the first board and the second board, and a heat sink is disposed on a surface of the casing to be extended in a direction perpendicular to a direction along which the first and second boards are arranged.

According to the fifth aspect of the embodiment, the heat-sink is disposed in such a manner. Therefore, compared to the heat-sink extended in a direction along which the first and second boards are arranged, the heat radiation of the first and second boards by the heat sink can be averaged.

### BRIEF DESCRIPTION OF THE DRAWINGS

In the accompanying drawings:

FIG. 1 is a diagram showing a system configuration according to an embodiment;

FIGS. 2A and 2B are diagrams showing a configuration of the power conversion unit according to the embodiment; and

FIG. 2C is a cross sectional view taken at line A-A of FIG. 2A.

### DETAILED DESCRIPTION OF THE PREFERRED EMBODIMENTS

### First Embodiment

With reference to the drawings, hereinafter is described the first embodiment in which a power conversion apparatus according to the present disclosure is adapted to a hybrid vehicle.

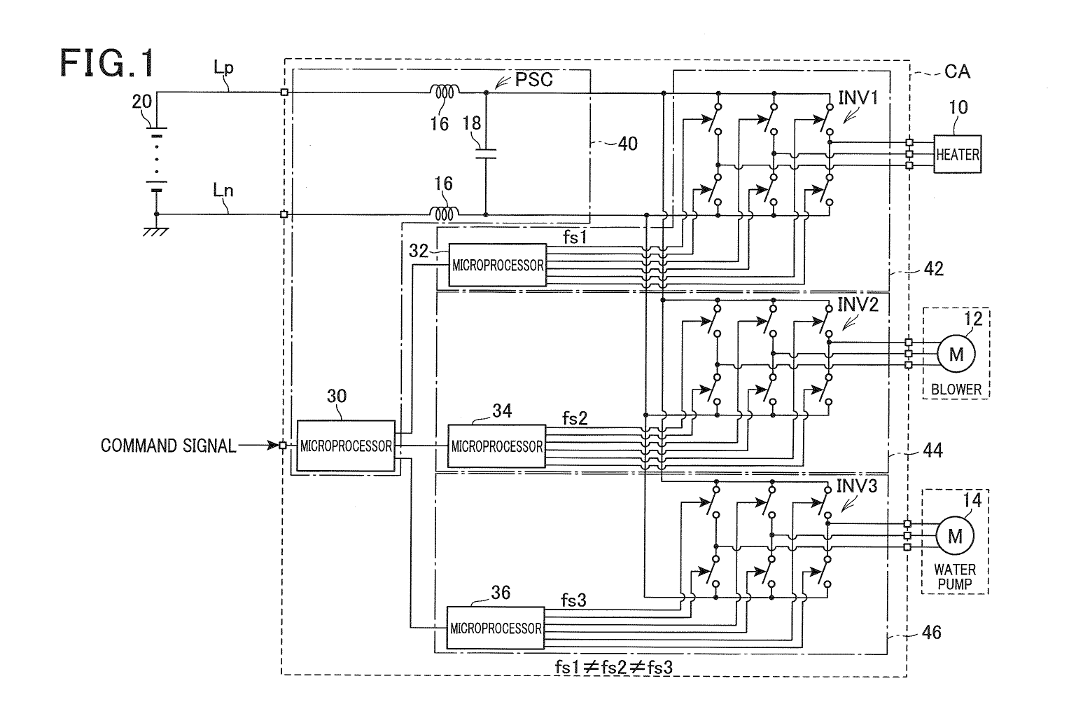

FIG. 1 is a diagram showing a system configuration according to the first embodiment.

A high voltage battery 20 as shown in FIG. 1 is a power source for supplying power to an on-vehicle main unit as a driving motor of the vehicle. The high voltage battery 20 is a secondary battery having a terminal voltage of about 100 volts, such as a lithium-ion battery or a nickel metal hydride battery. The negative terminal voltage of the high voltage battery 200 is isolated from the vehicle body. For example, a pair of capacitors are connected to both terminals of the high voltage battery and the connection point of the pair of capacitors is connected to the vehicle body so that a center value between a potential at the positive terminal and a potential at the negative terminal of the high voltage battery 20 equals the potential of the vehicle body.

The high voltage battery 20 is electrically connected to a pair of power supply lines Lp and Ln which are connected to the power supply unit PSC. The power supply unit PSC includes a normal mode choke coil 16 and a smoothing capacitor 18. The normal mode choke coil 16 is connected to each power supply line Lp and Ln and the smoothing capacitor 18 is connected to the power supply lines Lp and Ln in parallel.

The inverters INV1, INV2 and INV 3 (i.e., conversion circuit) connected in parallel with each other are connected to the power supply unit PSC. The inverter INV1 is used for applying three phase AC (alternating current) voltage to a heater 10 mounted on the on-vehicle air conditioner. The inverter 2 is used for applying three phase AC voltage to a motor 12 of a blower fan mounted on the on-vehicle 20. The inverter INV3 is used for applying three phase AC voltage to a motor 14 mounted on a water pump for cooling coolant in a cylinder block of the on-vehicle internal combustion engine. The above-described heater 10 is an electric heater designed to be driven by a three phase AC inverter similar to the inverters INV1, INV2 and INV3. The heater 10, the motor 12 of the blower fan and the motor 14 connected to respective inverters INV1, INV2 and INV3 serves as on-vehicle auxiliary units each corresponding to either the first auxiliary unit or the second auxiliary unit. The inverters INV1, INV2 and INV3 each corresponds to either the first circuit or the second circuit.

In this configuration, the inverters INV1, INV2 and INV3 share the power supply unit PSC. This is because capacitance value of the smoothing capacitor connected to the power supply unit PSC when the inverters INV1, INV2 and INV3 share the power supply unit PSC becomes smaller than the capacitance value of the smoothing capacitor when each inverter has own power supply unit. However, to decrease the capacitance value of the smoothing capacitor, the switching frequencies fs1, fs2 and fs3 corresponding to the respective inverters INV1, INV2 and INV3 should be set to be different values each other. Therefore, according to the first embodiment, these switching frequencies fs1, fs2 and fs3 are set to be different values.

The above-described inverters INV1, INV2, INV3 and the power supply unit PSC are accommodated in a single casing CA which is made of metal. The on-vehicle electrical load, i.e., the motors 12, 14 and the heater 10 are connected to the casing CA externally whereby the casing CA can be shrunk and arranged at a location where suffering damage if the vehicle collides with something can be avoided.

The above-described casing CA further includes microprocessors 32, 34 and 36 which generate control signals of the inverters INV1, INV2 and INV3 and outputs the control signals to the inverters INV1, INV2 and INV3, and the microprocessor 30. The microprocessor 30 receives a command value used for a control variable of each load (i.e., auxiliary unit) which is inputted externally (from an external device), assigns the command value to the respective microprocessors 32, 34 and 36 and outputs the command value to the respective microprocessors. Therefore, each of the microprocessor 32, 34 and 36 controls a phase-voltage corresponding to the respective inverters INV1, INV2 and INV3 in response to the command value inputted externally. Specifically, each of the microprocessors 32, 34 and 36 compares the phase-voltage of the inverter with a triangle-wave-shape carrier signal and generates the control signal of the inverters INV1, INV2 and INV3 based on the result of comparison between the phase-voltage and the carrier signal, so as to control the respective phase-voltage of the inverters. The microprocessor 30 receives the command value via an isolation means such as a photo coupler. The above-described microprocessor 30 and the power supply unit PSC are mounted on a power supply board 40, the inverter INV1 and the microprocessor 32 are mounted on a conversion board 42, the inverter INV2 and the microprocessor 34 are mounted on a conversion board 44 and, the inverter INV3 and the microprocessor 36 are mounted on the conversion board 46. The conversion boards 42, 44 and 46 each correspond to either the first board or the second board.

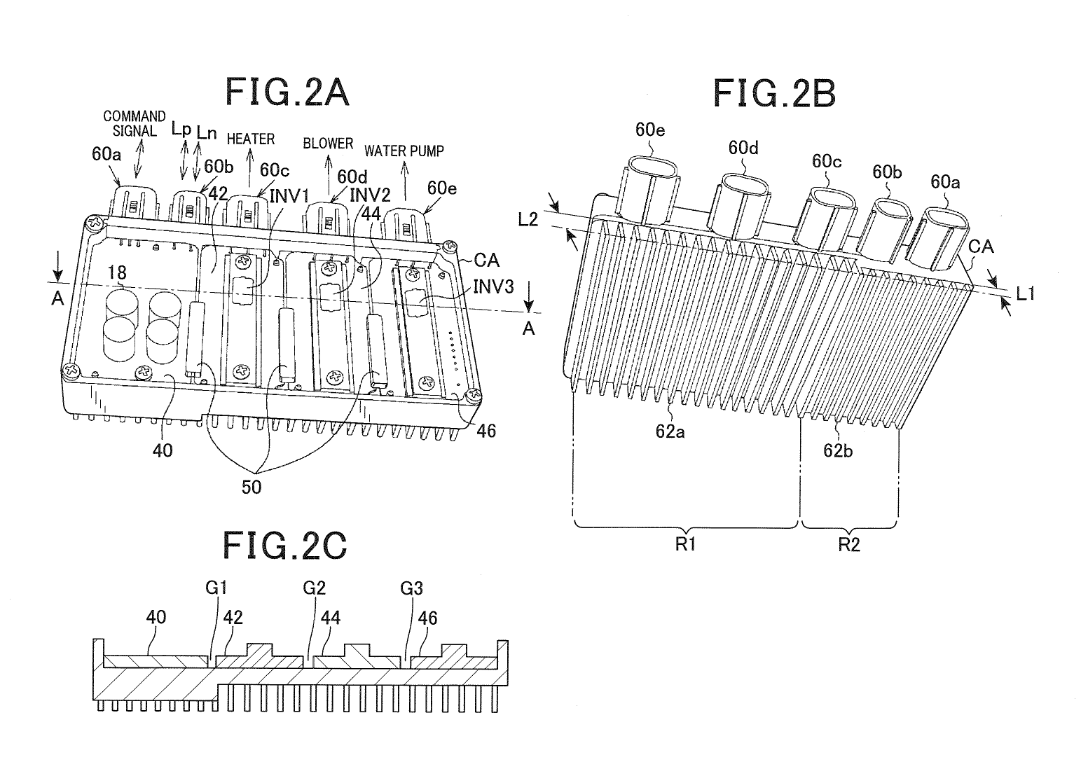

With reference to FIGS. 2A and 2B, a structure of the casing CA according to the first embodiment and how the power supply board 40, the conversion boards 42, 44 and 46 are accommodated in the casing CA, are explained as follows.

As shown in FIG. 2A, in the casing, the power supply board 40 and the conversion boards 42, 44 and 46 are arranged in a single row having gaps (G1, G2 and G3 as shown in FIG. 2C) therebetween. The power supply board 40 and the conversion board 42 are electrically connected via a connecting member 50. Similarly, the conversion boards 42 and 44 are electrically connected via the connecting member 50. Further, the conversion boards 44 and 46 are electrically connected via the connecting member 50 as well. The connecting member 50 is a conducting member being embedded into each of the end portions in adjacent two boards.

Specifically, the connecting member 50 connected between the power supply board 40 and the conversion board 42 includes a pair of power supply path connected to the output terminal of the power supply unit PSC (i.e., positive end and negative end of the smoothing capacitor 18) and a signal propagation path in which a command value used for generating the control signals of the inverters INV1, INV2 and INV3 is transmitted. The connecting member 50 connected between the conversion board 42 and the conversion board 44 includes a pair of power supply path connected to the output terminal of the power supply unit PSC (i.e., positive end and negative end of the smoothing capacitor 18) and a signal propagation path in which a command value used for generating the control signals of the INV2 and INV3 is transmitted. Further, the connecting member 50 connected between the conversion board 44 and the conversion board 46 includes a pair of power supply path connected to the output terminal of the power supply unit PSC (i.e., positive end and negative end of the smoothing capacitor 18) and a signal propagation path in which a command value used for generating the control signal of the INV3 is transmitted.

Regarding the above-described casing CA, connectors 60a, 60b, 60c, 60d and 60e which are made of resin are arranged on a side surface of the casing CA to be in single row shape. The connector 60a connects the above-described ECU 22 and the power supply board 40 (interface 30), and is disposed facing the power supply board 40. The connector 60b connects the above-described pair of power supply line Lp and Ln and the power supply unit PSC of the power supply board 40, and is disposed facing the power supply board 40. The connector 60c connects the heater 10 and the conversion board 42 (inverter INV1), and is disposed facing the conversion board 42. Moreover, the connector 60d connects the motor 12 of the blower fan and the conversion board 44 (inverter INV2), and is disposed facing the conversion board 44. The connector 60e connects the motor 14 of the water pump and the conversion board 46 (inverter INV3), and is disposed facing the conversion board 46.

FIG. 2B is a diagram showing a surface of the casing CA. As shown in FIG. 2B, a heat sink (ribs 62a and 62b) is arranged on the surface of the casing CA (arranged on R1 and R2 areas respectively as shown in FIG. 2B). The heat sink is arranged such that the longitudinal direction of each rib is disposed along a direction where the connectors 60a, 60b, 60c, 60d and 60e are extended from the casing CA. The Ribs 62a and 62b are used to expand an area being exposed to the atmosphere surrounding the heat sink whereby the heat exchange between the heat sink and the atmosphere can be enhanced.

As described above, in the first embodiment, the connectors 60a, 60b, 60c, 60d and 60e are disposed on a side surface of the casing CA so as to improve a working property when the casing CA is installed to an on-vehicle system. Assuming the connectors are arranged on both side surfaces (a pair of side surfaces facing each other) of the casing CA, it may be necessary to change the type of supporting the casing CA depending on which connectors on the both side surfaces are used for connecting. As a result, the working property may be decreased.

According to the first embodiment, the power supply board 40, the conversion boards 42, 44 and 46 are separated as individual boards. As a first reason, since the circuit board tends to bend to have curvature, when the circuit components to be mounted on the power supply board 40 and the conversion boards 42, 44 and 46 are mounted on a single circuit board, surface area of the board becomes larger so that the curvature may become significant. Therefore, if the circuit board has curvature, even when a mold material covers the surface of the circuit board to avoid a dielectric breakdown between wiring of the circuit board and the electronic devices, the mold material may be peeled off thereby degrading the insulating performance.

The second reason is to enhance a capability of heat radiation from the circuit board. Specifically, according to the first embodiment, the connectors 60a, 60b, 60c, 60d and 60e are arranged on only one side surface of the casing CA so that the power switching elements (i.e., inverter INV1, INV2 and INV3) need to be disposed on the one side in the casing CA and an amount of heat at the one side in the casing CA increases. Accordingly, the circuit board is divided to enhance the heat radiation when comparing with only one circuit board being used. Further, gaps are disposed between circuit boards, and the connecting member 50 having high heat-radiation characteristics connects between the circuit boards, whereby the effect of the heat radiation can be significant.

Moreover, the power supply unit PSC used for supplying power to the INV1, INV2 and INV3 mounted on the respective conversion circuit board 42, 44 and 46 is mounted to the power supply board 40, whereby heat radiation from the conversion boards 42, 44 and 46 can be further enhanced. That is, since the circuit components mounted on the power supply board 40 include a component such as smoothing capacitor 18 of which height is larger than that of the circuit components mounted on the conversion board 42, 44 and 46, as shown in FIG. 2B, the length of the rib 62b (L1) extended from the casing CA is set to be shorter than that of the rib 62a (L2) at the conversion circuits 42, 44 and 46. Therefore, assuming the power supply unit PSC is disposed to each of the conversion boards 42, 44 and 46, the length of the rib 62a extended from the conversion boards 42, 44 and 46 becomes shorter, thereby degrading heat-radiation characteristics of the conversion boards 42, 44 and 46.

The above-described rib 62a is formed to be perpendicular to a direction along which the conversion boards 42, 44 and 46 are arranged (i.e., a direction where the conversion boards are facing each other) so that the capability of heat-radiation in the respective conversion boards 42, 44 and 46 can be equivalent to each other.

The power supply board 40 including the above-described power supply unit PSC is disposed in the end portion of the casing CA so that the power supply board 40 can be shrunk. However, if the power supply board 40 is disposed in the central area of the casing CA, the power line which is connected to the positive and negative terminals of the smoothing capacitor 18 needs to be connected to the connecting member 50 disposed at the respective end portions of the power supply board 40. Therefore, size of the power supply board 40 becomes larger.

### Other Embodiment

The above-described embodiment can be modified as follows. Regarding the connecting member 50, it is not limited to the conducting member embedded into the end portions where adjacent circuit boards face each other. For example, a bonding wire soldered to a wiring portion in the respective circuit boards can be used to electrically connect the circuit boards.

Regarding the casing, it is not limited to the circuit boards arranged in a single row, however, the circuit boards can be arranged in double rows. In this case, to avoid interference between wirings, the connectors may preferably be disposed on an opposing pair of surfaces of a hexahedral casing.

Moreover, the casing is not limited to the hexahedron shape. For example, a casing having ellipse shape can be employed. The casing is not limited to a single casing, however, a plurality of casing can be used such that the a casing accommodating the power supply board 40, a casing accommodating the conversion board 42, a casing accommodating the conversion board 44 and a casing accommodating the conversion board 46 can be prepared separately and these casings are connected each other by a connecting member disposed on the respective side surfaces of the plurality of casing. In this case, capability of heat-radiation in the respective circuit boards can be further enhanced.

Regarding the connector, it is not limited to arrange all of the connectors on one surface of the hexahedron of the casing. For example, the connectors can be arranged on two surfaces that face each other. In this case, a difference between an average distance (average) from the surface facing the inverter to a surface of a pair of surfaces, and an average distance from the surface facing the inverter and the other surface of the pair of surfaces, can be reduced so that locations where the heat is produced can be balanced in the casing.

The connectors can be made of metal instead of resin whereby the heat-radiation performance at the connector portion can be enhanced.

Regarding the power supply board, it is not limited to the power supply board disposed at the end portion of the casing.

As to the power supply board, the power supply board may include not only the microprocessor 30, but also microprocessors 32, 34 and 36.

Regarding the number of conversion boards, it is not limited to three boards, for example, two boards or four or more conversion boards can be used. Further the number of auxiliary units connected to the respective conversion boards is not limited to three, for example, two auxiliary units or four or more auxiliary units can be used. Moreover, one conversion board does not necessarily include only one conversion circuit, however, one conversion board can include two or more conversion circuits.

Also, devices used for generating a control signal to control the switching element of the conversion board can be mounted on the conversion board.

Regarding the heat sink, it is not limited to the rib 62a and the rib 62b of which size is smaller than the rib 62a. However, the rib 62a and the rib 62b having the same size can be used, when the smoothing capacitor 18 included in the power supply unit PSC is shrunk so that the dimension of the casing CA is shrunk significantly.

Regarding the ribs 62a and 62b, it is not limited to a rib extending in a direction perpendicular to a direction along which the conversion boards are arranged. However, the ribs 62a and 62b can be extended in the direction along which the conversion boards are arranged.

Regarding the conversion circuit, it is not limited to three phase inverters. For example, a single phase inverter can be used for the heater 10. When a five phase motor is used for the motor 12 of the blower fan, the inverter used for the motor 12 will be a five phase inverter.

Further, it is not limited to a DC-AC conversion circuit having a switch element that selectively connects positive/negative terminals of a DC power source and a terminal of an on-vehicle auxiliary unit.

Moreover, it is not limited to the conversion circuits of which switching frequencies are changed depending on the conversion boards. It is not limited to a hybrid vehicle, that is, for storing energy supplied to an on-vehicle drive motor, only an output unit that outputs an electric energy (i.e., secondary battery, fuel cell) may be provided. Even in this case, the present disclosure has an advantage when the output unit is used for a power source of a plurality of on-vehicle auxiliary units such as a blower fan or a heater.

What is claimed is:

1. An apparatus for converting power of a power source used for a main unit mounted on a vehicle, comprising:
a first circuit that converts the power into a first power and supplies the first power to a first auxiliary unit mounted on the vehicle;
a second circuit that converts the power into a second power and supplies the second power to a second auxiliary unit mounted on the vehicle;
a first board on which the first circuit is mounted;
a second board on which the second circuit is mounted; and
a connecting member that electrically connects between the first board and the second board to allow the power of the power source to be conducted therebetween.

2. The apparatus according to claim 1, wherein the apparatus includes a casing that accommodates the first board and the second board, the casing including a first connector that electrically connects between the first circuit and the first auxiliary unit, and a second connector that electrically connects between the second circuit and the second auxiliary unit, the first and second connectors being disposed on the same surface of the casing.

3. The apparatus according to claim 1, wherein the apparatus includes a power supply board on which a power supply unit used for supplying the power of the power source to the first and second circuits is disposed; and a casing that accommodates the first board, the second board and the power supply board, the first board, the second board and the power supply board are arranged in a single row, and the power supply board is disposed in an end portion of the casing.

4. The apparatus according to claim 3, wherein the first and second circuits are operated at mutually different switching frequencies.

5. The apparatus according to claim 1, wherein the apparatus includes a casing that accommodates the first board and the second board, and a heat sink is disposed on a surface of the casing to be extended in a direction perpendicular to a direction along which the first and second boards are arranged.

6. An apparatus for converting power from a power source used for a main unit mounted on a vehicle, comprising:
a plurality of conversion circuits that converts the power into a plurality of power and supplies the plurality of power to a plurality of auxiliary units mounted on the vehicle;
a first board on which at least one conversion circuit among the plurality of conversion circuits is mounted;
a second board on which at least one conversion circuit among the plurality of conversion circuits is mounted; and
a connecting member that electrically connects between the first board and the second board to allow the power of the power source to be conducted therebetween.

7. The apparatus according to claim 6, wherein the apparatus includes a casing that accommodates the first board and the second board, the casing including a plurality of connectors that electrically connect between a plurality of conversion circuits and the plurality of auxiliary unit, the plurality of connectors being disposed on the same surface of the casing.

8. The apparatus according to claim 6, wherein the apparatus includes a power supply board on which a power supply unit used for supplying the power of the power source to the plurality of conversion circuits is disposed; and a casing that accommodates the first and second boards and the power supply board, the first and second boards and the power supply board are arranged in a single row, and the power supply board is disposed in an end portion of the casing.

9. The apparatus according to claim 8, wherein the plurality of conversion circuits are operated by mutually different switching frequencies.

10. The apparatus according to claim 6, wherein the apparatus includes a casing that accommodates the first board and the second board, and a heat sink is disposed on a surface of the casing to extend in a direction perpendicular to a direction along which the first and second boards are arranged.
